(19) United States
(12) Patent Application Publication
(10) Pub. No.: US 2026/0147329 A1
(43) Pub. Date: May 28, 2026

(54) System and Method for Real-Time Recipe Generation for Semiconductor Process Systems

(71) Applicant: Yang Pan, SINGAPORE (SG)

(72) Inventor: Yang Pan, SINGAPORE (SG)

(73) Assignee: Inspiring Atoms Pte Ltd, SINGAPORE (SG)

(21) Appl. No.: 18/957,847

(22) Filed: Nov. 24, 2024

(51) Int. Cl. G05B 19/4099

(52) U.S. Cl. CPC G05B 19/4099; G05B 2219/45031

(57) ABSTRACT

Disclosed herein are a system and method for real-time recipe generation in semiconductor manufacturing, utilizing digital twins, optimization techniques, and inverse neural networks. A search-and-match procedure uses metadata from simulated and real process cases to efficiently identify recipe and subsystem control parameters. When matches are unavailable, optimization algorithms or inverse neural networks refine these parameters. Applications include atomic layer etching (ALE) and other advanced manufacturing processes.

### FIELD OF THE INVENTION

The present invention pertains to the field of semiconductor manufacturing and, more specifically, to autonomous process recipe generation and adjustment during processing in a process system. The invention relates to systems and methods for enhancing the precision and efficiency of processes using an integrated digital twin and neural networks.

### BACKGROUND

Processes in plasma-based process systems are commonly employed in the fabrication of semiconductor devices, requiring precise control to ensure the production of features at the nanometer scale. Conventionally, process systems have relied on predefined recipes and user-defined calibration procedures to adjust subsystem control and recipe parameters, such as gas flow rates, RF power levels, and chamber temperature, which are crucial for the successful processing of material layers on a substrate.

However, due to the increasing complexity of semiconductor devices and the necessity for higher precision and repeatability, user-defined recipes and calibration procedures are no longer sufficient to meet the industry's advancing specifications. There is a growing need for improved process systems that can adapt to a wide variety of process scenarios without extensive user intervention.

The development of digital twins, which are virtual representations of physical systems, provides an opportunity to significantly improve semiconductor processes. A digital twin enables the simulation of real-world processes in a virtual environment, allowing for the prediction and optimization of process outcomes without consuming actual substrates.

Despite these advancements, the integration of digital twin technology into process systems for autonomous recipe generation and real-time adjustment has yet to be fully realized. The industry demands a process system capable of autonomously optimizing its operations in response to varying conditions, ensuring the highest level of precision and efficiency in substrate processing. This invention addresses these needs by providing an innovative process system, exemplified using ALE, empowered with an integrated digital twin capable of significantly improving processes in semiconductor manufacturing.

### SUMMARY

The present inventive concept is illustrated using an ALE system as an example, although it is applicable to any plasma-based or thermal-based process system. In some embodiments, the invention emphasizes the innovative feature of autonomous recipe generation in real-time. This autonomous operation is achieved through an integrated digital twin, which serves as a comprehensive digital replica of the entire process system, including its various subsystems.

The digital twin functions as an integral part of the system controller. In certain embodiments, it simulates the behavior and performance of the process, enabling the system to predict the outcomes of different recipes and subsystem control parameters before applying them to the physical process. This predictive capability facilitates the generation of recipes and subsystem control parameters optimized for different substrates under varying conditions.

Furthermore, in some embodiments, the digital twin incorporates models and neural networks that replicate the dynamics of subsystems, such as RF power delivery, gas flow regulation, and temperature control. This enables precise, autonomous adjustments to subsystem parameters, ensuring optimal operation.

In some embodiments, additional digital twins model chamber inner surfaces and an edge ring around the substrate, capturing aging effects within the process chamber. These additional digital twins, along with subsystem digital twins, a chamber plasma twin, and an ALE process digital twin, enable dynamic predictions of final process outcomes at any process step. Recipes and subsystem control parameters can be adjusted in real-time while the substrate is being processed. In some implementations, the digital twins are calibrated to improve prediction accuracy. In some embodiments, neural networks serve as implementations of digital twins, enhancing computational speed and efficiency. These neural networks operate in inference mode and are trained using simulation data generated from the digital twins.

A distinct feature of the present invention is the application of several procedures for real-time recipe generation. These procedures can reside in the system controller, tool controller, or group controller.

The first procedure employs a database of established process events. A process event represents a step in an ALE process. Metadata associated with the process event is generated. When a new process event is received by one of the controllers, a search engine matches the input fields of the new process event with established process events. If a match is achieved, a recipe and subsystem control parameters are derived based on the matched metadata.

If no match is found, the controller initiates a second procedure to generate the recipe using an optimization method. Alternatively, the recipe may be generated using an inverse neural network, implemented as software, hardware, or firmware.

This invention, characterized by real-time autonomous recipe generation and adjustment of subsystem control parameters, reflects a novel application of simulation and predictive models in semiconductor fabrication. The metadata search-and-match procedure rapidly identifies recipes or accelerates convergence of optimization methods.

### BRIEF DESCRIPTIONS OF THE DRAWINGS AND TABLES

To enhance clarity, the following descriptions reference the accompanying drawings:

FIG. 1A: Diagram of a process system using an ALE system as an example.

FIG. 1B: Functional diagram of a system controller configured to autonomously generate and adjust recipes in real-time.

FIG. 1C: Functional diagram of a system controller coupled to a tool controller, configured for autonomous recipe generation and adjustment.

FIG. 1D: Functional diagram of a system controller coupled to a group controller, configured for autonomous recipe generation and adjustment.

FIG. 1E: Functional diagram of a system controller coupled via a tool controller to a group controller, configured for autonomous recipe generation and adjustment.

FIG. 1F: Schematic diagram of a group of process systems and tools.

FIG. 2A: Timing diagram of the various steps of an ALE process exemplified in different plasma states.

FIG. 2B: Timing diagram of an ALE process during gas exchange steps.

FIG. 2C: Schematic representations of an exemplary structure before and after the ALE process.

FIG. 3: Schematic representation of a system digital twin for an ALE process.

FIG. 4: Neural network representation of the system digital twin.

FIG. 5: Flowchart outlining the training protocol for a digital twin of the ALE system, utilizing various neural networks.

FIG. 6A: Procedural flowchart for determining resonant frequencies using trained neural network models.

FIG. 6B: Flowchart detailing vacuum valve setpoint determination guided by neural network-based predictions.

FIG. 6C: Procedural diagram for establishing heating and cooling parameters through neural network-derived setpoints.

FIG. 7A: Flowchart describing recipe and subsystem parameter generation using the digital twin.

FIG. 7B: Flowchart for adjusting recipe and subsystem parameters during an ALE process step to achieve desired outcomes.

FIG. 8A: Flowchart for real-time process control utilizing the ALE system digital twin.

FIG. 8B: Flowchart for validating recipe and subsystem control parameters during an ALE process step.

FIG. 8C: Exemplary method of calculating structure progression in real-time.

FIG. 9A: Flowchart for recipe generation using a metadata search-and-match procedure based on metadata of previous process events.

FIG. 9B: Exemplary metadata structure.

FIG. 9C: Exemplary measurement engine.

FIG. 10: Schematic representation of an inverse neural network for real-time recipe generation.

FIG. 11: First option for recipe generation and adjustment using different approaches executed by various controllers.

FIG. 12: Second option for recipe generation and adjustment using different approaches executed by various controllers.

FIG. 13: Third option for recipe generation and adjustment using different approaches executed by various controllers.

Table 1: Summarizes parameters describing structures to be etched and structures after the ALE processing.

Table 2: Summarizes parameters describing process recipe parameters.

Table 3: Summarizes design parameters describing subsystem structures, topologies, and control parameters.

### DETAILED DESCRIPTIONS

In this section, we delve into the specific embodiments of the current invention to facilitate a deeper understanding. It should be noted that while implementations are described for clarity, alterations and modifications falling within the scope of the claims that follow are considered to be within the ambit of this disclosure. The detailed descriptions are intended to highlight the novel aspects of the invention, distinguishing it from conventional technology.

### Definition

ALE (Atomic Layer Etching): A plasma-based etching technique that removes material from a substrate layer by layer through alternating steps of surface modification and sputtering.

System Digital Twin: A virtual representation of a semiconductor manufacturing process system, simulating physical interactions and phenomena within the reactor to predict process outcomes and enable real-time control.

Reactor Digital Twin: A subset of the system digital twin focused on detailed predictions of ion and neutral fluxes, substrate surface temperature, and plasma dynamics, enabling subsystem integration.

Chamber Plasma Digital Twin: A component of the reactor digital twin that simulates plasma behavior, including electron, ion, and neutral particle distributions, plasma sheath properties, and plasma-related phenomena within the process chamber.

RF Digital Twin: A model of the RF subsystem, including power generators, resonators, and plasma source components, designed to optimize RF power delivery, impedance matching, and plasma initiation.

Gas Digital Twin: A model that simulates the gas distribution subsystem, including gas inflow, outflow, and chamber pressure dynamics, based on parameters such as gas flow rates, vacuum valve positions, and chamber geometry.

Temperature Digital Twin: A model that simulates the thermal environment within the process chamber, including substrate surface temperature, heater and chiller dynamics, and thermal conduction properties of the chuck.

Chamber Surface Digital Twin: A model capturing changes to chamber surfaces caused by plasma exposure, including material erosion, surface roughness, composition variations, and their effects on process performance.

Substrate Edge Digital Twin: A model focusing on edge-specific behaviors, accounting for variations in plasma, gas flow, and thermal conditions that affect uniformity and edge ring wear.

Process Digital Twin: A model that simulates the evolution of substrate structures during processing steps, incorporating recipe parameters, material properties, and structural dynamics. An ALE process digital twin is a specific implementation of this model.

Neural Network: A computational model trained using simulated and measured data to replicate digital twin behavior, enabling rapid, real-time predictions for process optimization.

Subsystem-Specific Neural Networks: Neural networks trained for individual subsystems (e.g., RF, gas dynamics, or thermal control), enhancing predictive accuracy in focused areas.

System Neural Network: A neural network derived from the system digital twin, optimized for real-time prediction and control of process parameters.

Inverse Neural Network: A neural network that reverses the mapping of a forward neural network. It takes target outcomes (e.g., post-etch dimensions, profiles) and calculates the input parameters (e.g., recipe and subsystem control parameters) needed to achieve those outcomes. It is trained using data from forward models or digital twins and is used for real-time recipe generation, enabling precise adjustments to meet desired output specifications.

Recipe Parameters: Variables defining the process steps in a semiconductor manufacturing process, including conditions and durations of surface modification and sputtering steps, cycle counts, and optional deposition timing.

Subsystem Control Parameters: Operational settings for individual subsystems, such as RF resonant frequencies, vacuum valve setpoints, gas flow rates, and heater or chiller setpoints.

Cost Function: A mathematical function evaluating process performance by comparing predicted outcomes to target specifications, used to guide optimization algorithms.

Measurement Engine: A component of the system controller that gathers real-time data, such as optical critical dimension (CD) measurements, to refine digital twin models and adjust process control parameters dynamically.

Plasma Sheath: The boundary layer of plasma near chamber surfaces, accelerating ions toward the substrate and playing a critical role in etching and sputtering processes.

Ion and Neutral Fluxes: The flow of ions and neutrals toward the substrate surface, determining the etching or deposition process behavior.

Real-Time Validation Procedure: A method for continuously evaluating process outputs to determine if recipe and subsystem parameters need adjustment to meet target outcomes.

Metadata Search-and-Match Procedure: A computational method used in semiconductor process systems to efficiently generate or adjust process recipes by searching a database of metadata representing previously simulated or real process events. Each metadata entry contains structured information, including input fields (e.g., process step, input parameters, and substrate structure parameters) and output fields (e.g., recipe and subsystem control parameters).

Plasma Impedance: A parameter representing the resistance of plasma to RF power, critical for optimizing RF subsystem performance.

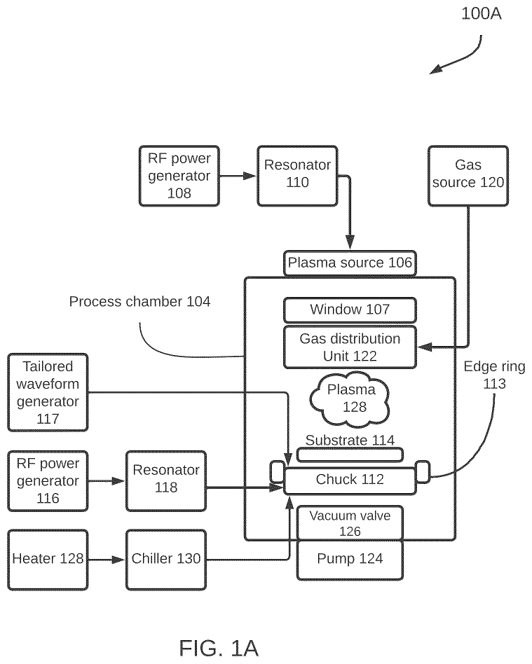

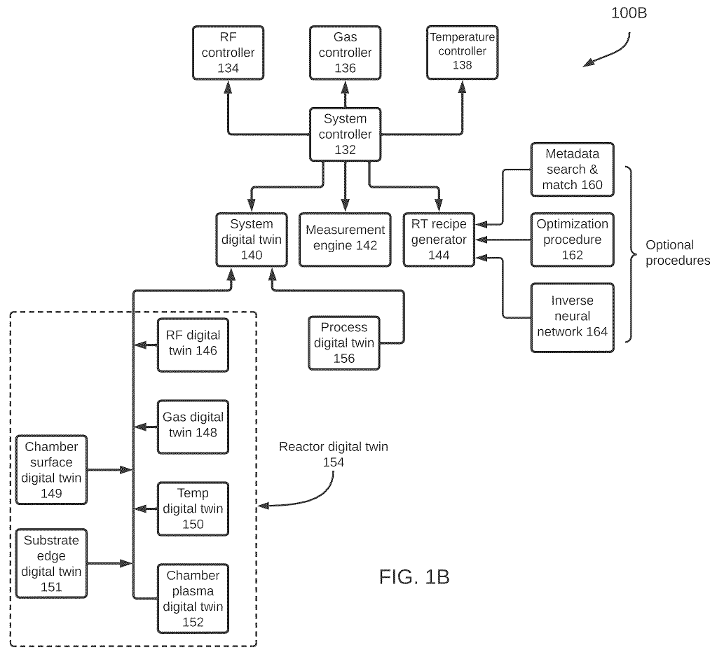

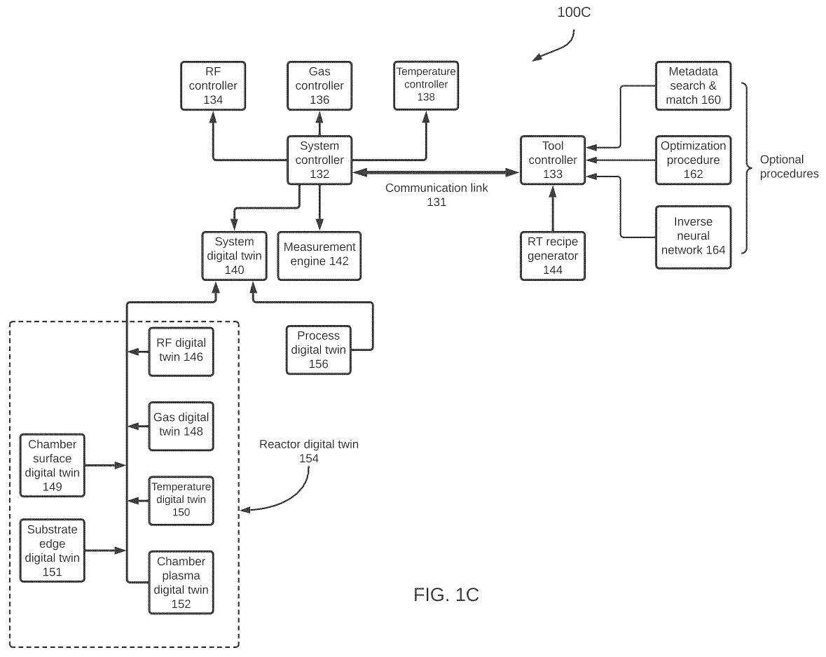

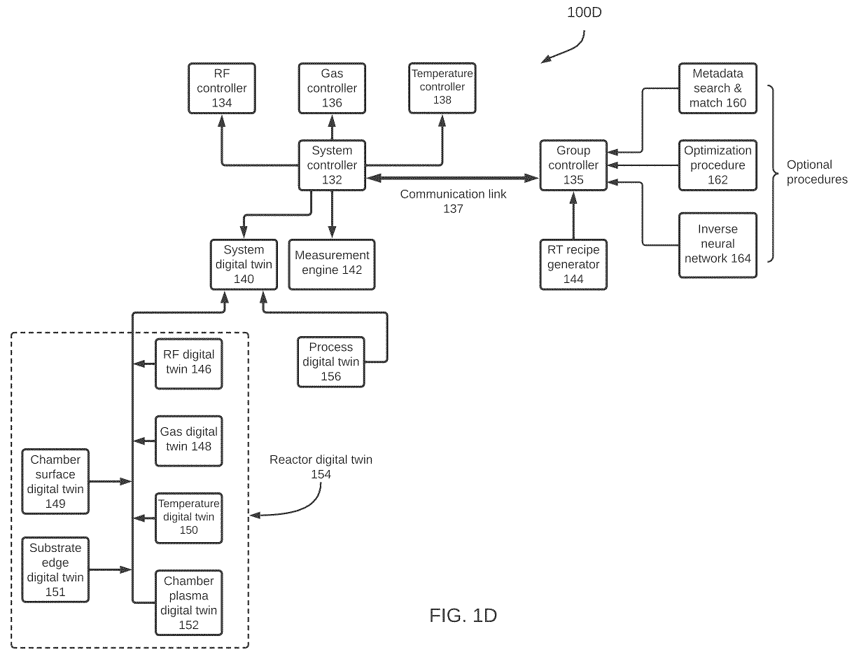

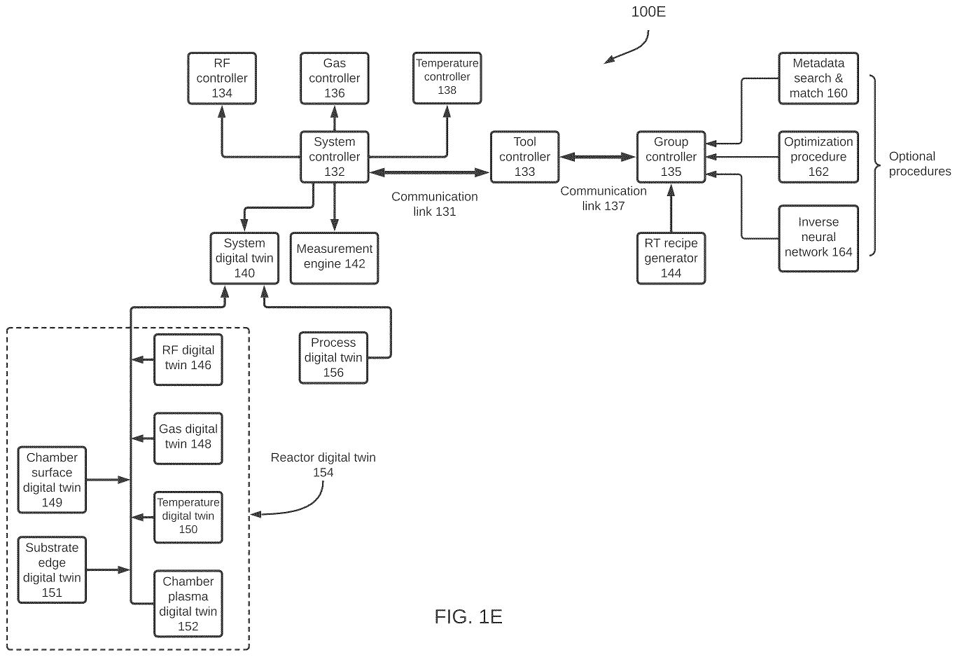

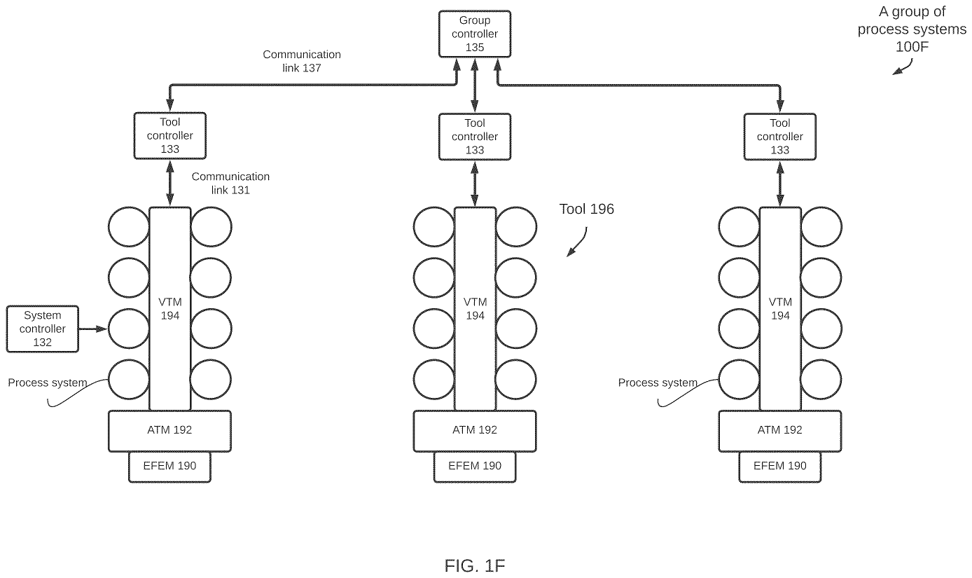

FIG. 1A illustrates an exemplary embodiment of an ALE process system, designated broadly at 100A. The ALE system is employed as an example to illustrate the present inventive concept without limiting its scope to other similar process systems, such as a reactive ion etching (RIE) system, a plasma-enhanced chemical vapor deposition (PECVD) system, an atomic layer deposition (ALD) system, a thermal etching system, or a thermal deposition system. The ALE system 100A comprises a process chamber 104, designed to maintain a vacuum suitable for plasma processing. Within this system, a plasma source 106 is configured to receive radio frequency (RF) power from an RF power generator 108 via a resonator 110. The plasma source 106 may take various forms, including but not limited to an inductively coupled plasma (ICP) source or a transformer coupled plasma (TCP) source.

The RF power generator 108 can operate at single or multiple frequencies, such as 13.56 MHz and/or 2.0 MHz. The resonator 110 plays a critical role in matching the output impedance of the RF generator 108 to the impedance of the plasma process chamber 104, accounting for the impedance characteristics of the transmission lines. This resonator 110 is typically constructed from inductors and capacitors and may, in some configurations, include mechanically adjustable capacitors. Alternatively, in some embodiments, the resonator 110 may exclude mechanically adjustable capacitors. Impedance adjustments can be achieved by varying the operating frequencies of the RF power generator 108 and the resonator 110. During the ALE process, the plasma exhibits variable states, each associated with different impedance levels. To ensure efficient energy transfer and minimize power reflection from the process chamber 104 back to the resonator 110, fine-tuning the frequency for each plasma state may be necessary to maintain the resonator 110 in resonance.

The process chamber 104 is further equipped with a chuck 112 to support a substrate 114. The chuck 112 may be implemented as an electrostatic chuck (ESC) or a vacuum chuck, depending on the process requirements. In a preferred embodiment employing an ESC, the chuck 112 is electrically connected to an RF power generator 116 via a resonator 118. Similar to the resonator 110, the resonator 118 requires tuning to achieve a resonant state by adjusting its operating frequency. It is worth noting that the operating frequencies of the RF power generator 116 may differ from those of the RF power generator 108. For instance, the RF power generator 116 may operate at a substantially lower frequency than the RF power generator 108.

The RF power generator 116 supplies a bias voltage to the chuck 112, typically delivered through a blocking capacitor, which is standard in the field but not shown in the figure. Alternatively, in some embodiments, a tailored waveform generator 117 may be used to provide the bias voltage to the chuck 112. The application of a tailored waveform can significantly narrow the distribution of ion energies, which are generated by the ignition of plasma 128 within the process chamber 104. Depending on the implementation, the tailored waveform generator 117 may be directly connected to the chuck 112 or interfaced with the RF power generator 116.

The RF subsystem, including the RF power generators, resonators, and plasma source, is managed by an RF controller 134, as depicted in FIG. 1B. This controller communicates with and operates under the supervision of a system controller 132. In addition, the process chamber 104 integrates a gas distribution unit 122 responsible for introducing process gases from a gas source 120 into the chamber. The gas distribution unit 122 may take various forms, such as a gas injector, a showerhead, or a side injection system positioned near the chamber's inner surfaces.

The gas source 120 is typically connected to the facility's gas supply and uses a combination of valves and mass flow controllers (MFCs) to regulate the flow of gases into the chamber.

The process chamber 104 also includes a pump 124, which may be a turbomolecular pump or another suitable type, to evacuate gases and by-products from the chamber. A vacuum valve 126, generally positioned atop the pump 124, modulates the evacuation rate. Chamber pressure is monitored by a manometer (not illustrated) and controlled by adjusting the position of a movable part of the vacuum valve 126 using an actuator. The position of this movable part corresponds to the setpoint of the vacuum valve 126. The gas distribution subsystem, which encompasses the gas distribution unit 122, gas source 120, pump 124, and vacuum valve 126, is managed by a gas controller 136, as shown in FIG. 1B. The gas controller is also integrated with the system controller 132 to enable coordinated operation of the ALE process system.

In one implementation, the process chamber 104 is sealed on top by a dielectric window 107 to maintain the vacuum required for the ALE process. An opening in the window may accommodate a gas injector for delivering process gases into the chamber. This opening must be carefully sealed to preserve the vacuum integrity of the process chamber 104. If a showerhead is employed, the showerhead itself may serve as the sealing component. The inner surface conditions of the window, showerhead, and injector are known to significantly impact process performance metrics, such as defect counts and etching rates. However, a detailed mechanistic understanding of these effects remains under investigation.

The process chamber 104 further incorporates a temperature control subsystem to maintain the desired thermal conditions within the chamber. As exemplified in FIG. 1A, the temperature of the chuck 112 is regulated by a temperature controller 138, as shown in FIG. 1B, which operates a heater 128 and a chiller 130, along with a temperature sensor (not depicted). The chuck 112 may feature multiple temperature zones, each independently controlled. Additionally, temperature regulation for other chamber components, such as the gas distribution unit 122 and chamber surfaces, may also be necessary and is implemented using standard industry practices.

In state-of-the-art etching process chambers, an edge ring 113 is typically used to modulate plasma, gas flow, and temperature conditions at the edge of the substrate 114. The edge ring 113 can be fabricated from materials such as silicon, quartz, silicon carbide, or ceramics. It may include mechanisms to modulate its operating temperature or electrical potential. As a consumable component, the edge ring's thickness gradually decreases over time due to prolonged exposure to ions and radicals in the plasma 128.

An exemplary ALE process alternates between a surface modification step A and a sputtering step B in a cyclic manner. During step A, chemically active radicals generated in the plasma 128 interact with the substrate surface, modifying it chemically. The plasma is generated by the plasma source 106, powered by the RF power generator 108. Halogen-based gases, such as chlorine, are often used to produce the necessary radicals. During this step, the bias to the chuck 112 is set to zero to minimize ion impact and preserve the integrity of the ALE process. Conversely, during step B, an inert gas such as argon is introduced to generate energetic ions that physically remove the chemically modified layer through sputtering. At this stage, a bias voltage is typically applied to the chuck 112 using the RF power generator 116, resonator 118, or tailored waveform generator 117, which may be combined for optimal performance. A purge step may be employed between steps A and B to facilitate the transition of gases.

For high aspect ratio (HAR) structures, an additional deposition step C may be included in the ALE cycle sequence at a less frequent rate. This step is designed to protect the sidewalls of etched structures and prevent lateral etching caused by the angular distribution of ions.

FIG. 1B showcases the ALE process system 100A functioning as an autonomous entity, attributed to the advanced capabilities of the system controller 132. This is further detailed in a functional diagram of the autonomous control system, labeled as 100B. The system controller 132 integrates with the RF controller 134, the gas controller 136, and the temperature controller 138, ensuring synchronized operation of these subsystems. A pivotal innovation of the current invention is the incorporation of a system digital twin 140 within the system controller 132. The system digital twin 140 effectively replicates the behavior of the ALE process system 100A, positioning the system controller 132 as an intermediary between the physical system and its virtual counterpart.

Within the system digital twin 140, there are additional components: the RF digital twin 146, the gas digital twin 148, and the temperature digital twin 150, each simulating the operations of their respective subsystems.

The RF digital twin 146 emulates the RF subsystem, including the RF power generators and resonators. Its implementation may involve simulation models such as SPICE models or neural networks trained on a combination of simulated and actual measured data. In some embodiments, a hybrid approach utilizing both models and neural networks is employed for increased accuracy.

The gas digital twin 148 replicates the functions of the gas distribution subsystem, encompassing components such as the gas source 120, the gas distribution unit 122, the pump 124, the vacuum valve 126, and the manometer (not illustrated). This digital twin may utilize fluid dynamics models, analytical models, empirical models, or neural networks trained on both simulated and measured data. Hybrid implementations combining these approaches may also be used.

The temperature digital twin 150 simulates the temperature control subsystem, which includes the heater 128, the chiller 130, and temperature sensors (not illustrated). This digital twin may also account for temperature regulation in other chamber components, such as the gas distribution unit 122. Its implementation may include numerical models, analytical models, neural networks trained on simulated and real data, or a combination of these approaches.

Each subsystem within a specific chamber delivers slightly different outputs due to variations in the subsystem manufacturing process. For real-time process control, the digital twins (146, 148, and 150) must be calibrated periodically to reflect the actual performance of their respective subsystems. Calibration ensures that the digital twins capture any significant drift in subsystem outputs over time.

During plasma processes like the ALE process, the inner surfaces of the process chamber 104 are exposed to energetic ions and radicals for extended periods. Over time, the material thickness of these surfaces may degrade, causing drift in etching parameters, especially around the substrate's edge. It is critical to monitor and quantify such changes within the process chamber. Preventive maintenance procedures can also introduce significant changes in process performance due to conditioning effects on the chamber's inner surfaces.

A chamber surface digital twin 149 is designed to capture changes in chamber surfaces as a function of plasma exposure time, including the effects of preventive maintenance procedures. This digital twin focuses on selected surfaces, such as the inner surfaces of the window, the showerhead, and the injector. Due to the lack of fully established mechanistic models and rapid advancements in plasma-resistant materials, the digital twin 149 may use empirical models, look-up tables, neural networks, analytical models, numerical models, or any combination of these approaches.

A substrate edge digital twin 151 addresses the challenges of achieving consistent performance at the substrate's edge, where plasma, gas flow, and temperature behave differently compared to the central substrate areas. The edge ring 113 is used to modulate process performance at the edge, but its thickness decreases over time due to prolonged plasma exposure. The digital twin 151 may incorporate empirical models, look-up tables, neural networks, analytical models, numerical models, or a combination of these methods to account for these edge-specific effects. The chamber plasma digital twin 152 simulates the internal plasma dynamics within the process chamber 104. It incorporates input from other digital twins (146, 148, 150, 149, and 151) to create a comprehensive model of electron, ion, and neutral particle behavior. This model may represent particle distributions in three dimensions or as a simplified two-dimensional version, either continuously over time or as discrete snapshots. It characterizes properties such as particle energy, velocity, and density.

For instance, in a scenario using an ICP plasma source, RF power from the RF generator 108 via the resonator 110 generates an electromagnetic field that creates electrons near the ICP source. These electrons interact with the field to produce ions and neutral particles, a process well-established in the field. The digital twin 152 can simulate the formation of the plasma sheath near the substrate and the inner surfaces of the chamber, accounting for historical particle distributions influenced by real-time controls such as frequency adjustments, pressure regulation, and temperature management.

The chamber plasma digital twin 152 may employ sophisticated numerical models requiring significant computational resources. To improve efficiency, a neural network trained on numerical modeling outputs may be used. Real-world measurements, such as magnetic field distributions recorded using B-dot probes or electron density measurements from hairpin probes, can enhance the neural network's predictive accuracy. In some implementations, analytical models may supplement numerical and neural network-based approaches.

Understanding the behavior of particles within the ALE process system is crucial for modeling ion and neutral fluxes to the substrate surface. The plasma sheath's properties, pivotal for accurate flux calculations, are integral to these models. These fluxes, essential for the ALE process, may also be measured with specialized apparatus to further refine neural network training data.

The digital twins—including the RF digital twin 146, the gas digital twin 148, the temperature digital twin 150, and the chamber plasma digital twin 152—form the reactor digital twin 154. The chamber surface digital twin 149 and the substrate edge digital twin 151 enhance accuracy by capturing the effects of “drift” caused by plasma exposure on chamber components. This integrated digital twin provides critical outputs, including ion and neutral fluxes to the substrate surface, temperature distributions, and bonding distributions, enabling precise real-time process control.

The overarching system digital twin 140 extends to include the process digital twin 156, which uses ALE as an example. The process digital twin 156 integrates outputs from the reactor digital twin 154 to simulate the evolution of substrate structures during the ALE process. It inputs data on substrate characteristics such as mask layers, thickness, material properties, dimensions, and profiles of structures, as well as the properties of the target layer for etching.

Beyond this, the ALE digital twin 156 processes recipe parameters like the durations for steps A and B, the total ALE cycle count, insertion points and durations for step C, along with any pulse modulation specifics such as pulse duration and duty cycles, if applied within the ALE steps.

Other parameters, particularly those related to subsystems like RF power settings, are already encompassed by the respective digital twins (146, 148, 150). It should be noted that there are many variations in implementing an ALE process. For example, the step C is optional and may not be used for certain applications like etching a film with a thickness less than 100 nm. There are also many variations in implementing pulse schemes for the plasma source and the bias. All such variations fall into the present inventive concept.

For implementation purposes, while a Monte Carlo simulator or other numerical simulators might provide high accuracy, they often demand considerable computational resources, which can be a drawback for real-time applications. An alternative approach involves deploying a neural network within the ALE digital twin 156. Initial training with simulated data followed by subsequent refinement using empirical data ensures a robust, responsive system. In some implementations, the ALE digital twin 156 may be developed as a hybrid, employing both analytical and numerical models or combining analytical models with neural networks. The self-limiting behavior of the ALE process lends itself well to analytical modeling, efficiently capturing fundamental ALE responses. Numerical models or neural networks can be incorporated to address deviations from the ideal process, like lateral etching or depth loading effects. This synergy between models enhances the precision of predictions while maintaining computational efficiency.

The system controller 132 is additionally equipped with a measurement engine 142 and a real-time (RT) recipe generator 144, both of which synergistically collaborate to autonomously generate an ALE process recipe, along with the parameters for subsystem control. The measurement engine 142 is specially designed to capture real-time data. For example, optical critical dimension (CD) data can be collected by optical sensors in real-time to gauge the structure progression under the ALE process at a particular step. Furthermore, subsystem control parameters can deviate from targeted ones because of variations and drifts in the subsystem components. The measurement engine 142 may capture the subsystem parameters in real-time and consequently improve the prediction accuracy of the digital twins.

The RT recipe generator 144 can be used to design a process recipe prior to the substrate being loaded onto the chuck for processing. The RT recipe generator 144 can also take the outputs of the measurement engine 142 in real-time and apply the system digital twin 140 to adjust recipe and subsystem control parameters for the remaining steps of the ALE process.

The recipe can be generated through various optional procedures. In one implementation, the recipe can be generated through a metadata search-and-match procedure, designated as 160. The procedure 160 is enabled by a database that captures previous process events, either through simulation applying the system digital twin 140 or through real process events. The process event represents a step in the ALE process. Each of the process events is abstracted into metadata that is searchable by a search engine. The metadata includes input fields, which include but are not limited to the ALE step, input parameters at the step, output parameters after completing the ALE process, fixed subsystem parameters, fixed recipe parameters, and in-situ measurement data. The metadata further includes output fields such as subsystem control parameters and unfixed recipe parameters. The procedure 160 attempts to match the input fields of a new process event with an existing process event in the database. If a match is found, the subsystem control parameters and the unfixed recipe parameters are identified successfully through the procedure 160. The recipe can then be generated. A cost function can be defined to decide if the match is successful. The database can be expanded progressively, including more and more process events. For example, the process events can be simulated in the background continuously without inferences from a user. Therefore, the probability of matching will increase progressively.

If a match fails via the procedure 160, an optimization procedure 162 can be applied to generate a recipe based on the system digital twin 140. Nevertheless, the search may still yield a process event close to the desired one. Hence, the process event can be used as a starting point for an optimization procedure to determine the recipe and the subsystem parameters. In an alternative approach, the recipe can also be generated through utilizing a trained inverse neural network, designated as procedure 164. The procedures 162 and 164 will be discussed in detail in the following sections.

In one embodiment, as shown in FIG. 1B, the optional procedures (160, 162, and 164) are local to the process system 100A as part of the functionalities of the system controller 132.

In another embodiment of the system control, designated as 100C, as illustrated in FIG. 1C, the optional procedures (160, 162, and 164) are implemented as functionalities of a tool controller 133. The RT recipe generator 144 is a part of the tool controller 133. As depicted in FIG. 1F, a tool 196 includes multiple process systems (or chambers). A group of process systems, designated as 100F, includes multiple tools. The tool 196 further includes an equipment front-end module (EFEM) 190, an atmosphere transfer module (ATM) 192, and a vacuum transfer module (VTM) 194. The tool controller 133 is coupled to the system controller 132 via a communication link 131. The communication link 131 may include electrical cables, optical fibers, wireless communications, or any combinations of the above. The group of process systems is controlled by a group controller 135. The group controller 135 may be coupled to the tool controller 133 or directly to the system controller 132 via communication link 137. The communication link 137 may include electrical cables, optical fibers, wireless communications, or any combinations of the above.

In yet another embodiment of the control system, designated as 100D, as showcased in FIG. 1D, the optional procedures (160, 162, and 164) for generating the recipe are implemented as functionalities of the group controller 135. The group controller 135 is coupled directly to the system controller 132. The RT recipe generator 144 is a part of the group controller 135, which is coupled to the system controller 132 via the communication link 137.

In still another embodiment of the control system, designated as 100E, as shown in FIG. 1E, the optional procedures (160, 162, and 164) for generating the recipe are implemented as functionalities of the group controller 135, which is coupled to the system controller 132 via the tool controller 133. The communication link 137 is used to couple the group controller 135 and the tool controller 133. The communication link 131 is employed to couple the tool controller 133 and the system controller 132.

Detailed descriptions of various embodiments will be elucidated in the subsequent paragraphs of this disclosure. Across all embodiments, digital twins are utilized to enhance the system's performance. In certain embodiments, advanced optimization procedures are applied to initially formulate the recipe and the subsystem control parameters, which are then subjected to iterative optimization.

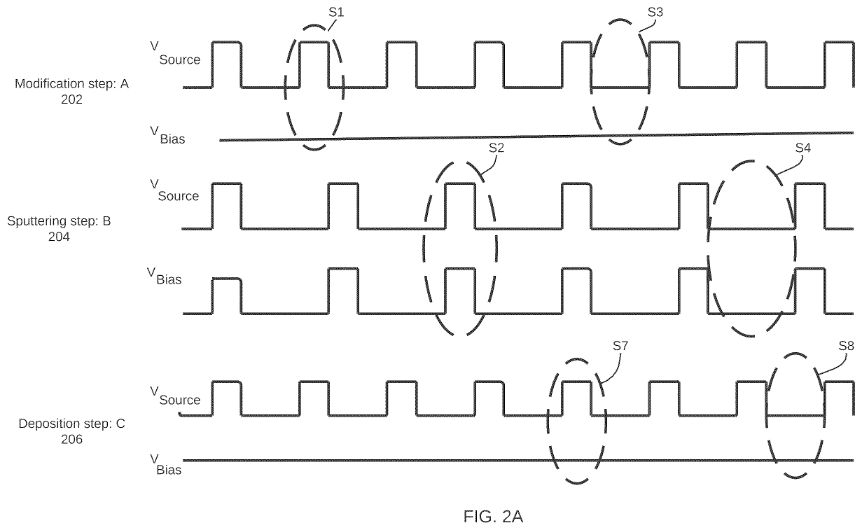

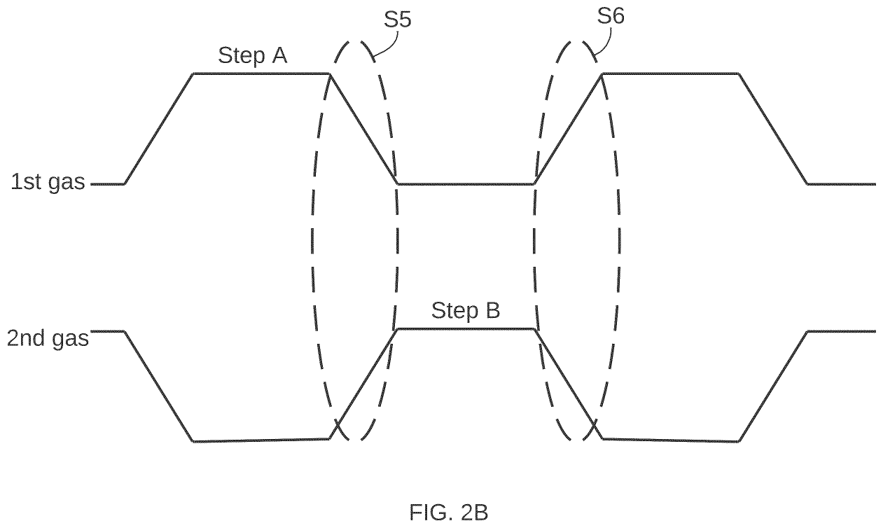

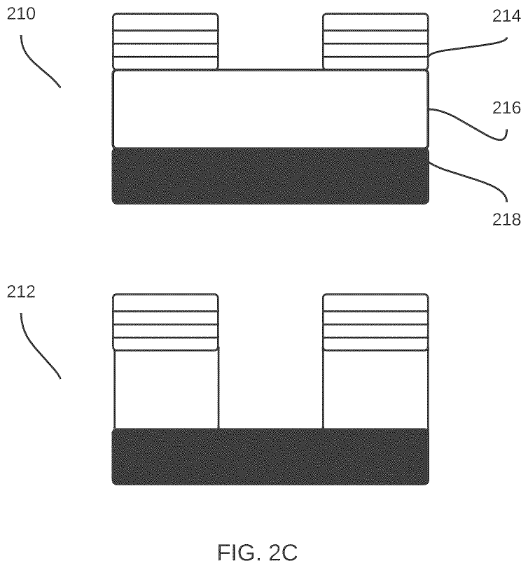

FIG. 2A depicts various states in steps A, B, and C. State S₁ represents a state in the surface modification step A 202, where the plasma source 106 receives RF power from the RF power generator 108, while the bias voltage for the chuck 112 is set to be zero. This state is crucial for enabling surface modifications without a chuck bias, thereby avoiding energetic ions impacting the substrate surface. State S₂ reflects a state in the sputtering step B 204, where the chuck is biased by either the RF power generator 116 and/or the tailored waveform generator 117. This bias voltage is essential for the sputtering process as it directs the energy and trajectory of ions toward the substrate.

State S₃ captures another state within the surface modification step 202, where both the plasma source 106 and the chuck 112 cease to receive RF power. This state remains significant as radicals generated during S₁ continue to modify the substrate surface. State S₄ illustrates a state in the sputtering step B 204, wherein both the bias and the source are turned off. This state can be significant for allowing byproducts to diffuse out of a high aspect ratio (HAR) structure.

States S₇ and S₈ pertain to the deposition step C 206. State S₈ is used to generate ions and neutrals for deposition, while state S₈ allows the generated neutrals to diffuse into desired positions within the HAR structure. These states facilitate the deposition of a layer to protect the sidewalls of structures being etched during the ALE process.

FIG. 2B showcases an exemplary ALE process utilizing the process system 100, including transitions between process gases. During state S₅, the first gas for the modification step 202 is ramped down, and the second gas for the sputtering step is ramped up. This transition is critical for switching between the two distinct steps (A and B) of the ALE process. Conversely, state S₆ represents the ramping up of the first gas for the surface modification step A 202 and the ramping down of the second gas for the sputtering step B 204, marking the preparation for a return to the modification step.

FIG. 2C illustrates an exemplary incoming structure 210 and a structure 212 post-ALE process. The incoming substrate 210 includes a mask layer 214, a targeted layer 216 to be etched by the ALE process, and a layer 218 underneath the targeted layer. As shown in Table 1, the dataset describing the incoming mask includes, but is not limited to, materials for the mask stack, thickness, mask dimensions, profile, uniformity, and loading created from previous process steps. In some implementations, the mask stack is a photoresist layer. In other implementations, the mask layer may be a hard mask, such as a carbon layer, silicon oxide layer, silicon nitride layer, or a combination thereof. These properties need to be disclosed to enable the ALE digital twin. The dataset also includes information about the targeted layer 216, such as material properties, thickness, and the characteristics of the underlying material, which may affect the profile near the bottom of the structure post-ALE.

As further detailed in Table 1, parameters describing the structure post-ALE 212 include dimensions, profile, uniformity, and loading. The profile may be characterized by parameters such as top and bottom dimensions, bowing, and the position of bowing. Loading includes the isolation-to-dense pattern dimension and depth differences post-ALE process.

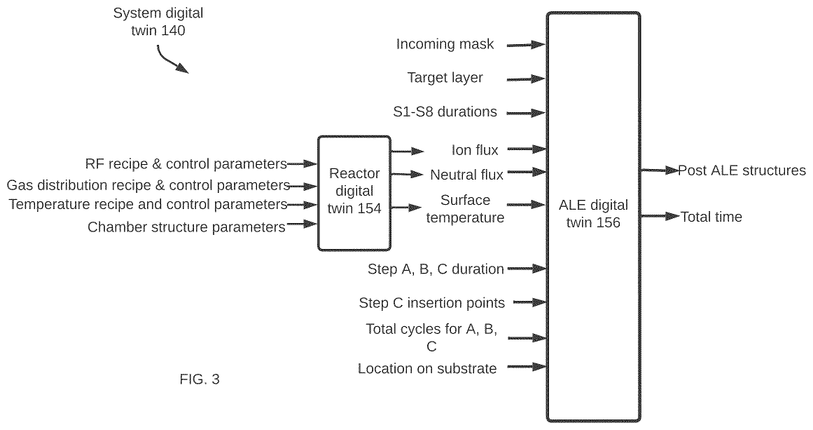

FIG. 3 provides a schematic overview of the system digital twin 140 for the ALE system 100, offering a comprehensive digital representation of the physical ALE process. The system digital twin 140 includes the reactor digital twin 154, which assimilates various subsystem parameters and chamber structure parameters into its computational framework. These inputs are essential for accurately simulating the physical interactions and phenomena occurring within the ALE reactor. Recipe parameters are also incorporated to predict plasma performance in the process chamber 104.

The reactor digital twin 154 outputs detailed predictions of ion and neutral fluxes, as well as substrate surface temperature. These outputs serve as key inputs to the ALE process digital twin 156, bridging subsystem parameters with process outcomes. The ALE process digital twin 156 further incorporates parameters specific to the ALE process, including mask parameters for the incoming substrate and parameters for specific layers targeted for the ALE process, as shown in Table 1. Additionally, it integrates detailed ALE recipe parameters, such as the duration of specific states (S₁ to S₈) durations of steps A through C, insertion points for step C, and the total number of cycles for each step, as shown in Table 2. Spatial data pinpointing the locations of structures to be processed on the substrate is also included. These inputs enable the ALE process digital twin 156 to project outputs, including the characteristics of post-ALE process structures (as shown in Table 1) and the overall processing time for the ALE cycle.

For implementation, the ALE process digital twin 156 may utilize a model-based approach, a neural network, or a hybrid of both, depending on the complexity of the ALE process, the need for real-time feedback, and prediction accuracy requirements. Neural networks, if employed, can leverage the foundation provided by the system digital twin, using computational techniques such as Monte Carlo simulations or numerical models. The simulation data generated by the system digital twin 140 can be used to train the neural network, with additional real-world measurements validating and refining the simulated data to enhance robustness and reliability.

This digital twin framework provides a virtual yet precise reflection of the ALE process, enabling improved understanding, control, and optimization of the complex interactions and parameters that govern ALE system performance.

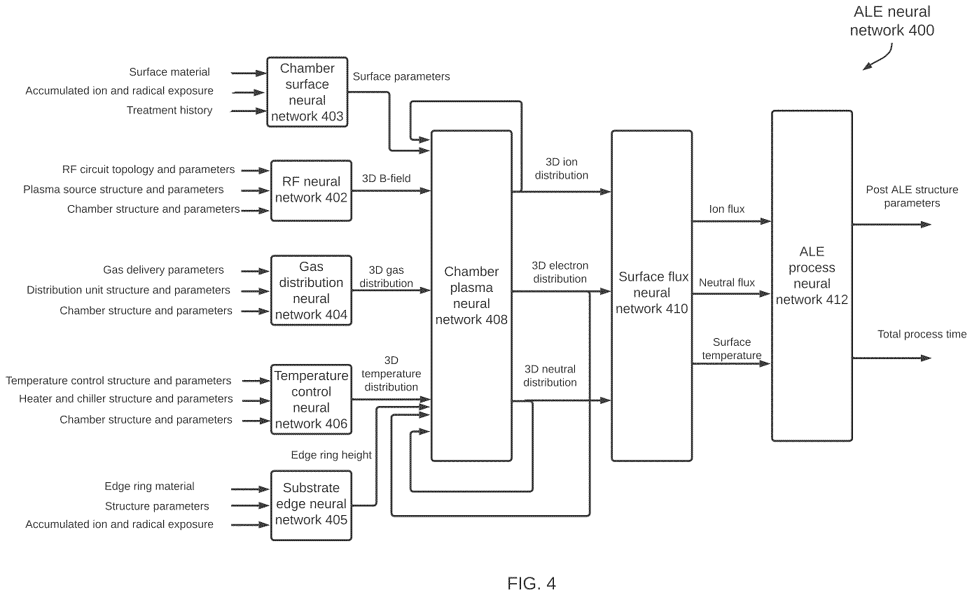

FIG. 4 illustrates an exemplary process system represented as a neural network 400, where the subsystems are captured using various neural networks. For example, the RF digital twin 146 forms the basis for training the RF neural network 402. Taking the plasma source 106 attached to the RF power generator 108 and resonator 110 as an example, a SPICE model can simulate the generator, resonator, and their transmission lines. This SPICE model provides initial AC current and voltage data for the plasma source coils 106, assuming an initial plasma impedance. A numerical simulator then applies Maxwell's equations to predict the electromagnetic field distribution within the process chamber 104.

The simulation data generated by the RF digital twin 146 is used as a training set for the RF neural network 402. Inputs to the neural network include RF circuit topology and parameters such as the values of inductors, capacitors, resistors, and transistors in the generator and resonator, along with effects from transmission lines. Additional parameters, such as the size, position, resistivity, and coil turn count of the plasma source, are incorporated into the training process. The RF neural network 402 also considers chamber structure parameters, including dimensions, positions of the chuck and window, and material properties. Some parameters, measurable through sensors, are assigned greater weight during training. For instance, sensors may monitor current and voltage changes in the coils or measure reflected power at the resonator's output node 110. A B-dot sensor with multiple small coils could be positioned in the chamber to map the magnetic field distribution, ensuring that the RF neural network 402 aligns closely with observed physical behaviors.

Modeling the bias portion of the RF subsystem using a neural network focuses on the electric field initially generated in response to applied RF power. Unlike the magnetic field related to plasma generation, the bias pertains to the electric field's effects on the substrate surface.

Transitioning to the gas dynamics within the system, we examine the gas distribution neural network 404, which is derived from the gas digital twin 148. Numerical fluid dynamics forms the foundation for determining the gas distribution within the process chamber 104. This interplay involves the gas inflow from the gas distribution unit 122, the outflow managed by the pump 124 and the vacuum valve 126 and is influenced by the chamber's conductance and volumetric parameters. While numerical simulations provide accuracy, their computational intensity and time constraints necessitate a more efficient approach for real-time applications, leading to the development of the gas distribution neural network 404.

The gas distribution neural network 404 is trained on simulation data incorporating parameters such as the types and flow rates of gases, the design of the gas distribution unit 122, the pump's capacity 124, the position of the movable part of the vacuum valve 126, and the chamber dimensions and conductance. The position of the movable part is controlled by the setpoint of the vacuum valve 126. The gas distribution unit 122, implemented as an injector, a showerhead, or a combination of both, significantly affects gas distribution within the process chamber 104. Key design parameters include the size, quantity, and distribution of channels in the injector and the showerhead. Gas pressure within the process chamber, monitored by a manometer, provides real-world data that enhances the training of the gas distribution neural network 404. This measured data often carries more weight than simulation data to ensure the model's accuracy under actual conditions.

The temperature control neural network 406, derived from the temperature digital twin 150, maps the thermal landscape within the chamber, particularly at the substrate surface. Training for the temperature control neural network 406 originates from numerical models simulating heat interactions and distributions. Inputs include chuck and chamber parameters that affect thermal conduction. In scenarios utilizing an electrostatic chuck (ESC), the thermal properties of the ESC and the efficiency of heat conduction, influenced by helium pressure as a medium, are critical. Setpoints for heating and cooling elements, such as the heater 128 and chiller 130, and chamber specifications, including size and construction materials, are also integral inputs. Temperature readings from sensors positioned in the chuck 112 and chamber 104 provide real-world data, which may carry greater weight in training to closely mimic the physical environment. This combination of simulated and measured data ensures the neural network's predictions are highly accurate and applicable to the ALE process system.

The inner surfaces of the chamber, such as the window, gas injector, and showerhead, are subject to degradation over time due to plasma exposure. The chamber surface neural network 403 models these “memory” effects, drawing inputs such as surface material, accumulated ion and radical exposure, and treatment histories. Outputs include surface parameters like structure, composition, roughness, and sticking coefficient, which collectively influence chamber radical and ion distributions. Training data for the chamber surface neural network 403 originates from the chamber surface digital twin 149 and can be augmented with measured data obtained from specially designed testing apparatus. This neural network mimics the digital twin with significantly improved computational efficiency.

Consumable parts in the process chamber 104, such as the edge ring, experience dimensional changes due to prolonged plasma exposure. For instance, a reduction in edge ring thickness can substantially affect process performance at the substrate's edge. The substrate edge neural network 405 mimics the substrate edge digital twin 151, achieving greater computational efficiency. Input parameters include the edge ring material, structural parameters such as initial height, and exposure history to ions and radicals in the plasma. Outputs include the remaining height of the edge ring. In some implementations, the temperature and electrical potential at the edge may also serve as inputs to predict the edge ring erosion rate or outputs for the chamber plasma digital twin or neural network.

FIG. 4 illustrates further an ALE reactor where the outputs of subsystem neural networks serve as inputs to the chamber plasma neural network 408. This network, based on the chamber plasma digital twin 152, provides a sophisticated representation of the plasma dynamics within the etching chamber. Simulating particle movements within the plasma involves either Monte Carlo methods or numerical plasma simulators to visualize the three-dimensional distributions of electrons, ions, and neutrals. The lighter electrons move faster than ions, forming a plasma sheath on chamber surfaces. This sheath accelerates ions toward the substrate, a critical aspect for sputtering but potentially disruptive during surface modification.

The chamber plasma neural network 408 integrates simulation data for rapid and efficient computation. Measured data from chamber sensors, such as optical sensors detecting light emission from neutrals and hairpin sensors gauging electron density, refine the network's predictive capabilities. Measured data is weighted more heavily than simulated data to align outputs with actual system behavior.

The chamber plasma neural network 408 employs a recurrent neural network (RNN) design, allowing it to process temporal sequences. This design enables the network to incorporate snapshots of plasma conditions into future predictions, reflecting the dynamic evolution of the plasma state. Once the network computes three-dimensional distributions, ion and neutral fluxes to the substrate surface are determined using the surface flux neural network 410. These fluxes, along with substrate surface temperature, are inputs for the ALE process neural network 412.

The ALE process neural network 412, trained on data from the ALE digital twin, provides outputs such as post-ALE structure parameters (listed in Table 1) and total process time. Together, the chamber plasma neural network 408 and surface flux neural network 410 generate valuable insights beyond fluxes, including surface temperature and chemical bonding distributions. These outputs are critical for fine-tuning the ALE process to achieve precise etching and high-quality substrate surfaces.

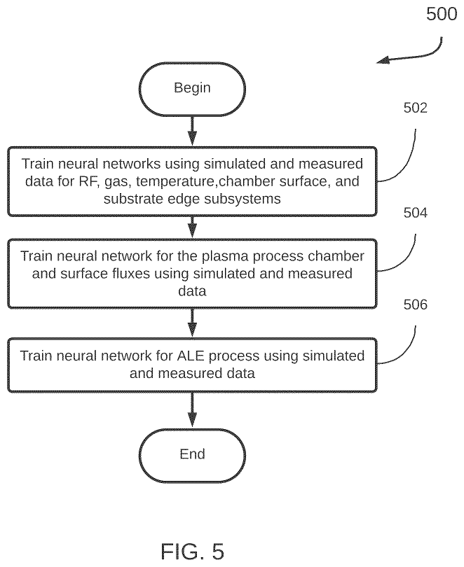

FIG. 5 presents a flowchart outlining the methodology for training the ALE neural network 400. The process 500 begins at step 502, where the subsystem neural networks (402, 404, 406, 403, and 405) are trained using simulated data. Following this, at step 504, the neural network 408/410 is trained utilizing simulated data. In step 506, the ALE process neural network 412 is trained with simulated data, including the outputs from steps 502 and 504. The training regimen for each neural network is further refined by incorporating measured data related to the subsystems, the plasma chamber, and the ALE process itself. Techniques to increase the weight of measured data include constructing a cost function with higher weights assigned to measured data or reusing measured data with artificially added low-level noise to enhance robustness.

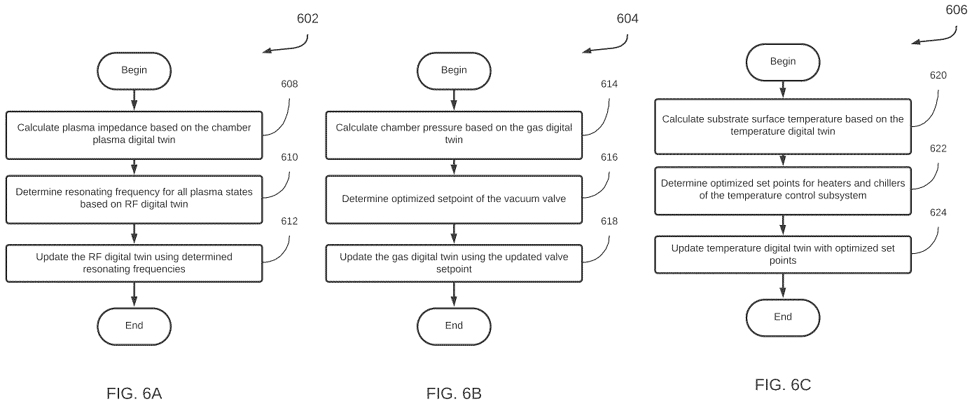

FIG. 6A depicts a procedural flowchart for identifying resonant frequencies corresponding to plasma states, each characterized by a unique plasma impedance in the ALE process. The process 602 starts at step 608, where plasma impedances are computed using the chamber plasma digital twin 152. At step 610, resonant frequencies for the various plasma states are determined based on the RF digital twin 146. In step 612, the RF digital twin 146 is updated to reflect the newly determined resonant frequencies.

FIG. 6B sets forth a flowchart delineating the procedure for establishing the position of the movable part of the vacuum valve according to the gas digital twin 148. The process 604 begins at step 614, where the chamber pressure is calculated using the gas digital twin 148 based on an initial position of the movable part. Step 616 involves determining the optimized position of the movable part to achieve the desired chamber pressure. Finally, the gas digital twin 148 is updated in step 618 to integrate the optimized position or associated setpoint.

FIG. 6C illustrates a flowchart detailing the procedure for defining setpoints for a heater and a chiller. The process 606 starts with step 620, where the substrate surface temperature is computed by the temperature digital twin 150 using initial setpoints for the heater 128 and the chiller 130. In step 622, optimized setpoints are determined to maintain the substrate temperature within the desired range, utilizing the temperature digital twin 150. Step 624 updates the temperature digital twin 150 to include the optimized setpoints.

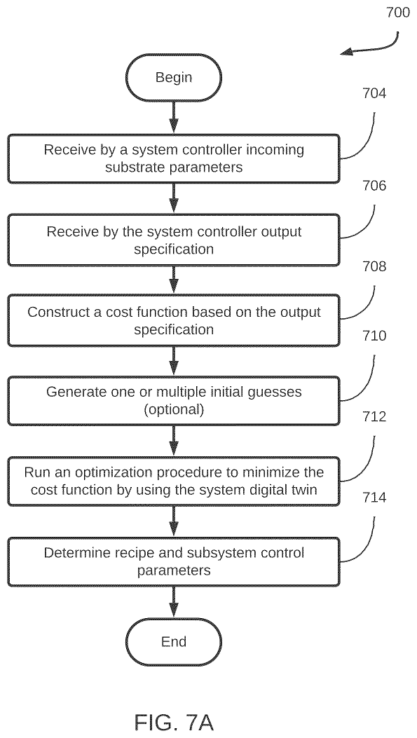

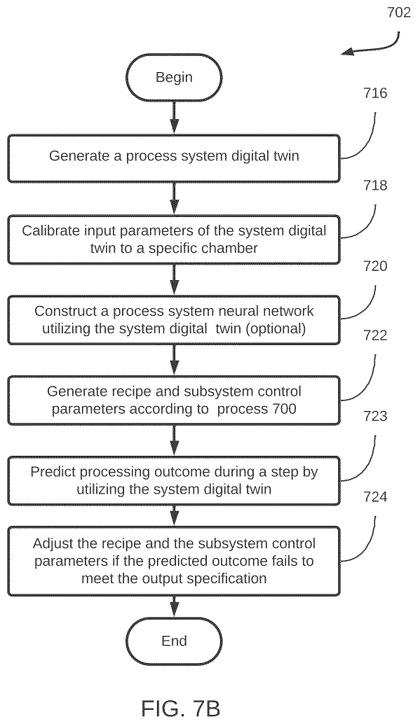

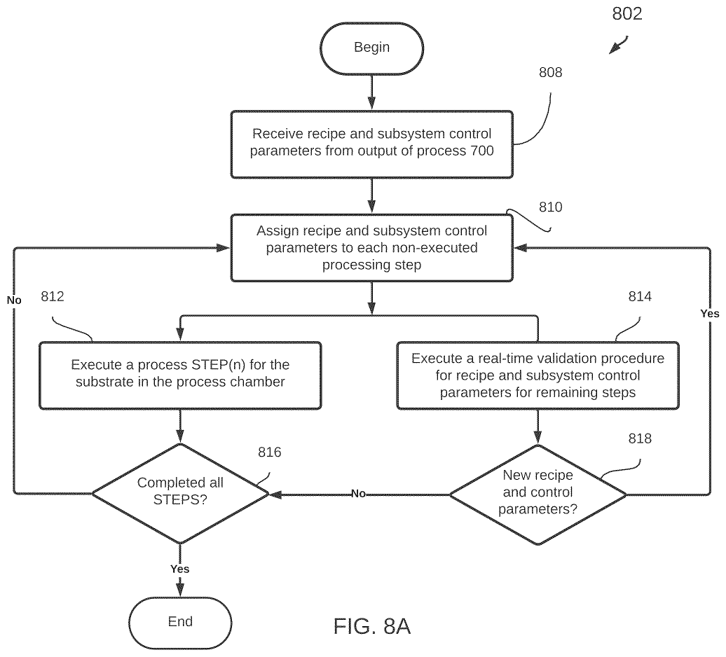

FIG. 7A presents a flowchart outlining a method for formulating recipe parameters and subsystem control parameters using the system digital twin 140. The process 700 begins at step 704, where the system controller 132 acquires incoming substrate parameters, as detailed in Table 1. In step 706, the system controller 132 retrieves the output parameters for the structures to be etched. At step 708, a cost function is constructed based on these output specifications.

A cost function for the ALE process is typically formulated as a square function pertaining to each output parameter of the structure post the ALE processing. The cost function can be defined as:

$$c = {\sum }_{i = 1}^{N} {w}_{i} {( {p}_{i} - {p}_{itarget} )}^{2} , \qquad [ 1 ]$$

where c is the cost, wᵢ is the weight, and pᵢ is a normalized output parameter like critical dimension at a selected vertical coordinate, p_{itarget} is the normalized target value of the output parameter, and N is serial number of the parameter. If multiple structures are evaluated, the cost function can be further expressed as:

$$C = {\sum }_{j = 1}^{M} {W}_{j} {c}_{j} , \qquad [ 2 ]$$

where C is the accumulated cost across multiple structures, Wⱼ is the weight, and cⱼ is the cost for one structure. The method can take several or many structures across a substrate like a 300 mm wafer. The number of the structures is labeled as M. The method can further take different structures or different parts of the structure to quantify various loading effects.

Initial estimations for recipe and subsystem control parameters are devised at step 710, serving as a starting point for the optimization algorithm executed at step 712. This optimization aims to minimize the cost function.

In some implementations, optimization of a cost function is achieved using iterative algorithms designed to minimize error or maximize efficiency in system performance. Common methods include Stochastic Gradient Descent (SGD), Newton's method, Adam, and Conjugate Gradient. SGD operates by iteratively updating model parameters in the direction of the negative gradient of the cost function, computed over randomly selected subsets of the data (batches). This approach balances computational efficiency with convergence speed, particularly in scenarios involving large datasets. Newton's method utilizes second-order derivatives (the Hessian matrix) to refine parameter updates, enabling rapid convergence by approximating the curvature of the cost function, though it may require significant computational resources for Hessian calculation. Adam, an adaptive gradient-based method, combines momentum and scaling of gradients to dynamically adjust learning rates, ensuring stable and efficient convergence even in non-convex optimization landscapes. In some embodiments, hybrid strategies combine these techniques to leverage the efficiency of gradient-based methods, the precision of second-order optimizations, and the adaptive nature of advanced algorithms, enhancing the robustness and performance of the overall optimization process.

At the conclusion of this process, at step 714, the recipe parameters and subsystem control parameters are established. As shown in Table 3, subsystem control parameters include, but are not limited to, resonant frequencies for the RF generators and resonators, the position of the valve, and the setpoints for the heater and chiller. The resonant frequencies correspond to each plasma state characterized by a unique plasma impedance in the ALE process. After the distributions of electrons, ions, and neutrals in the plasma chamber are determined by the chamber plasma digital twin 152, the plasma impedances can be computed. Subsequently, resonant frequencies for various plasma states are identified based on the RF digital twin 146.

The position of the movable part of the vacuum valve 126 can be determined using the gas digital twin 148. Initially, the chamber pressure is calculated using the gas digital twin 148, based on an assumed valve position. Subsequently, the optimized position of the valve is determined to achieve the desired chamber pressure.

The setpoints for the heater and chiller are established using the temperature digital twin 150. It is important to note that the substrate surface temperature may also be influenced by ion flux during the sputtering step of the ALE process. Consequently, determining the surface temperature—and thereby the setpoints for the heater and chiller—may require collaboration between the chamber plasma digital twin 152 and the temperature digital twin 150.

FIG. 7B illustrates a flowchart depicting the process 702 for real-time control of the ALE process to achieve desired outputs. Process 702 begins at step 716 with the generation of the ALE system digital twin 140, as shown in FIG. 2. At step 718, the input parameters of the digital twin 140, including those for various subsystems, are calibrated to a specific chamber. Due to manufacturing variations, each subsystem exhibits slight differences. The calibration step captures these variations to ensure the digital twin can predict process performance with high accuracy. For example, variations in electronic components may lead to differences in resonant frequencies or delivered power to the chamber. Optionally, this calibration step may be performed periodically.

At step 720, an ALE process system neural network 400 is constructed using the system digital twin 140. The ALE system neural network 400 significantly improves computing speed and efficiency in inference mode, a critical requirement for real-time process control. The neural network 400 can be implemented in various forms, including software, firmware, hardware (e.g., GPU), or analog computing, as known in the art. The neural network is trained using data generated by the system digital twin 140, augmented by measured data. At step 722, a recipe for the ALE process is generated based on process 700. Subsystem control parameters, as described in FIG. 6, are also generated. A unique feature of the present invention is the ability to predict the outcome of the ALE process at any processing step, using the system digital twin 140 or the ALE system neural network 400, as shown in step 723. This capability allows the system controller 132 to adjust recipe and subsystem control parameters for remaining steps to achieve desired outputs, as depicted at step 724.

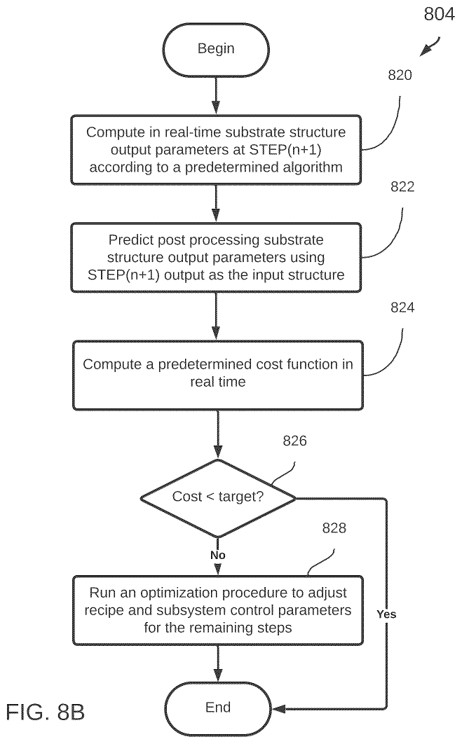

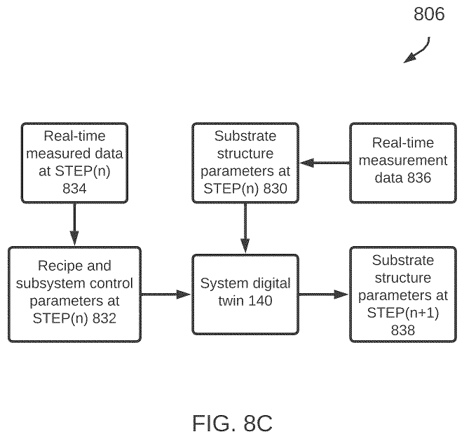

A more detailed description of the real-time process control is provided in FIG. 8 (A-C). Process 802 begins at step 808, where the system controller 132 receives recipe and subsystem control parameters derived from process 700. At step 810, these parameters are assigned to each step of the ALE process. In one exemplary implementation, steps 812 and 814 are parallel processes. At step 812, an ALE STEP(n) is executed by the system controller 132, where “n” represents any step in the process. Simultaneously, at step 814, the system controller performs a real-time validation procedure to determine whether the outputs of the ALE process meet the required specifications.

At step 818, the system controller 132 evaluates whether the validation procedure indicates the need for a new set of recipe and subsystem control parameters. If required, the system assigns the new parameters and returns to step 810 to continue the process. If the process has not been completed, the ALE process continues at step 816.

FIG. 8B illustrates a flowchart for an exemplary validation procedure. Process 804 begins at step 820, where the system controller 132 computes the substrate output parameters for STEP(n+1) during STEP(n), based on a predetermined algorithm, as shown in FIG. 8C and labeled as 806. The system digital twin 140, or its neural network implementation 400, is employed for this computation. Inputs to the digital twin 140 include recipe and subsystem parameters for STEP(n) 832, measured data from the measurement engine 142 (834), substrate structure parameters at STEP(n) (830), and structure measured data 836. The digital twin 140 predicts the substrate structure parameters at STEP(n+1), enabling a prediction of the final structure parameters. It is noted that predictions for structures beyond STEP(n+1) may not include real-time measurements and instead rely on model-based inputs.

After the final structure parameters are predicted, the cost function is computed at step 824. If the cost is below the target, the process 804 concludes. Otherwise, an optimization procedure is initiated at step 828 to adjust the recipe and subsystem control parameters for the remaining steps.

Recipe parameters include the completion time for the ALE process, commonly referred to as the “endpoint” in etching processes. Traditional endpoint detection methods often involve monitoring process parameters, such as optical emission spectroscopy signals indicating byproduct release from the underlying layer. The present invention introduces a novel approach by continuously predicting the entire structure progression throughout the process.

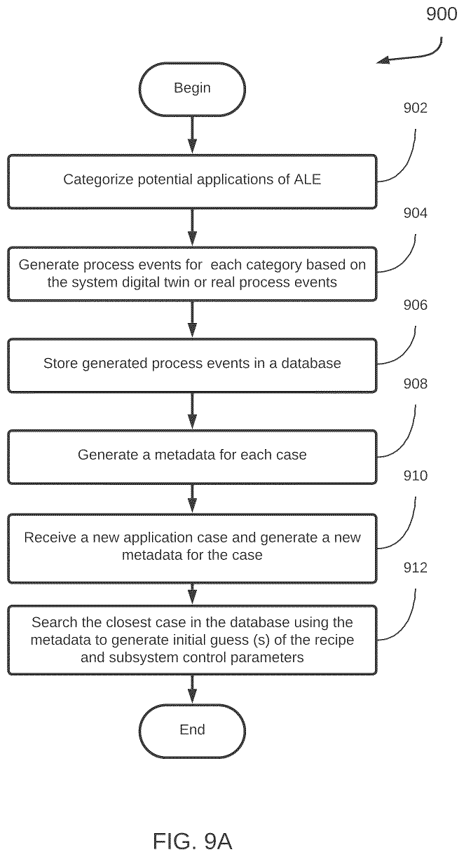

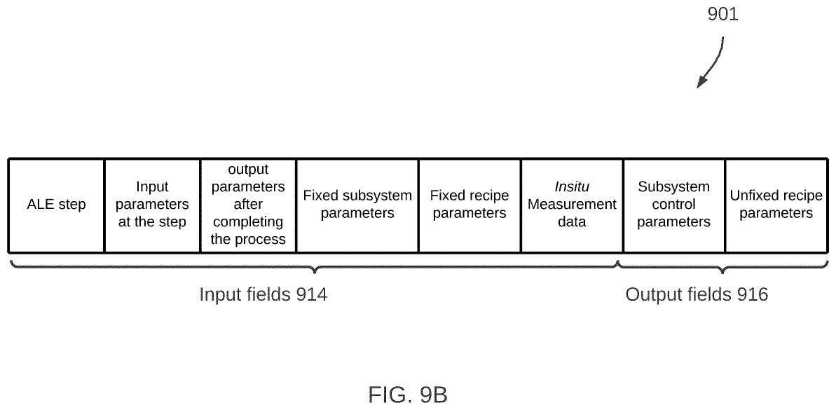

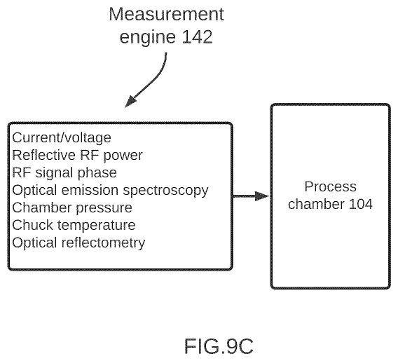

FIG. 9A showcases a flowchart for process 900, which generates a database of established process events. Each established process event is represented by metadata. Process 900 begins with step 902, where potential applications of ALE are categorized. These categorized applications include, but are not limited to, hard mask opening for patterning various stacks, high-aspect-ratio (HAR) etching for silicon substrates, and HAR etching for dielectric stacks. At step 904, process events are generated for each category. A process event represents a step in the ALE process and may include various critical dimensions (CD), depths, stacks, and profile requirements. The system digital twin 140 can be employed to generate these process events, which can be produced continuously in the background.

At step 906, the generated process events are stored in a database, and each process event is represented by metadata at step 908. An exemplary metadata structure is illustrated in FIG. 9B, denoted as 901. The metadata includes input fields 914 and output fields 916. The input fields 914 include, but are not limited to, the ALE step, input parameters for the step, output parameters after completing the ALE process, fixed subsystem parameters, fixed recipe parameters, and in-situ measurement data. The ALE step may range from the initial step to the final step of the process. The input parameters and output parameters include those detailed in Table 1. Fixed subsystem parameters and in-situ measurement data from various sensors are also incorporated into the input fields 914. The output fields 916 include subsystem control parameters, such as resonant frequencies for the RF system, and unfixed recipe parameters, as discussed earlier.

At step 912, the system controller 132 receives a new process event and applies procedure 162 by attempting to match the input fields of the new process event with any existing process event in the database. If a match is achieved, the subsystem control parameters and unfixed recipe parameters are successfully generated. If matching cannot be accomplished, the system controller applies process 800 by executing the optimization procedure 160 to generate the recipe. The optimization procedure can leverage the closest matched process event as an initial guess for the parameters, aiding in rapid convergence.

The measurement engine includes various sensors, as exemplified in FIG. 9C. These sensors include, but are not limited to, an IV probe for measuring RF current and voltage, an RF power sensor for detecting reflective RF power, phase sensors for monitoring RF current or voltage phases, optical emission spectroscopy sensors for analyzing neutral compositions in the chamber, a manometer for chamber pressure, temperature sensors for chuck temperature measurement, and sensors employing optical reflectometry techniques to monitor structure progression on the substrate.

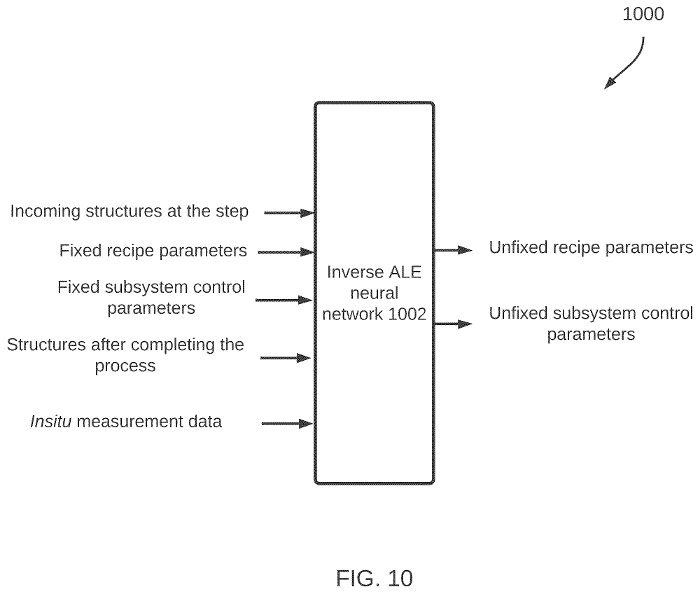

An alternative procedure for generating the recipe, in cases of failed matching, involves using an inverse neural network, as illustrated in FIG. 10, denoted as 1000. The inverse neural network 1002 is a reconstructed network based on the ALE neural network 400. Inputs to the inverse neural network 1002 include the incoming structures at a given step. These structures may include the original substrate structures prior to the ALE process or partially etched structures. Inputs also include the target layer, which may be a single layer or a combination of multiple layers, as well as fixed recipe parameters and fixed subsystem parameters. Additionally, the input data incorporates the desired structures after completing the ALE process. The outputs from the inverse neural network 1002 comprise unfixed recipe parameters and unfixed subsystem parameters.

The inverse neural network 1002 may be trained using data generated by the ALE neural network 400 or directly by the system digital twin 140. The inverse neural network 1002 can be integrated as part of the system controller 132, the tool controller 133, or the group controller 135. Preferably, the inverse neural network 1002 is incorporated into the system controller 132 to reduce latency caused by communication delays.

In one implementation, the inverse neural network 1002 is deployed as software stored within one of the controllers (132, 133, or 135). In another implementation, it is realized as hardware, which may include SRAM, DRAM, resistive RAM, MRAM, or phase-change RAM. This hardware can operate in digital or analog formats. Implementations may also involve GPUs, CPUs, or firmware. All such variations fall within the scope of the present invention.

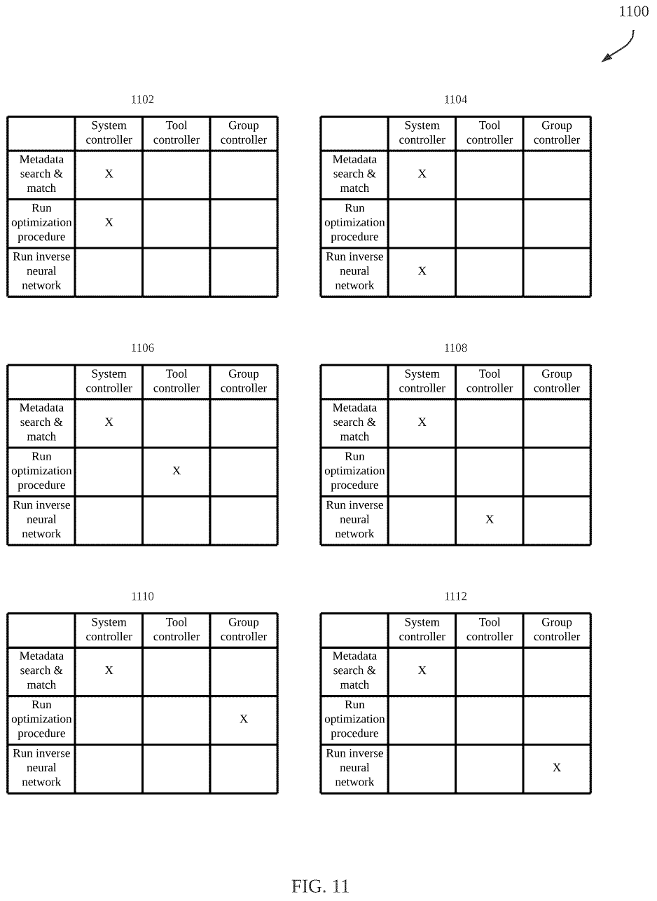

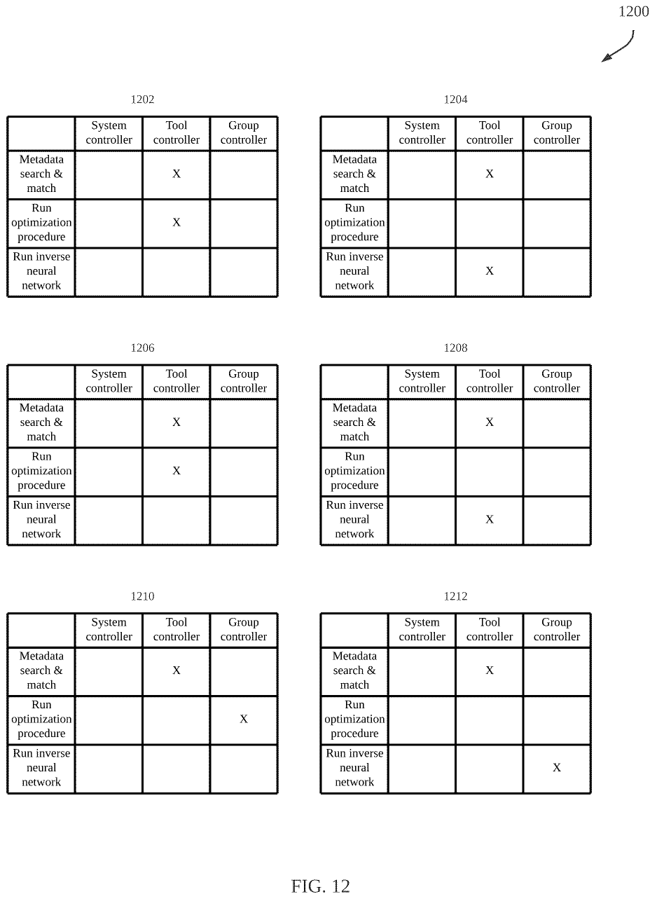

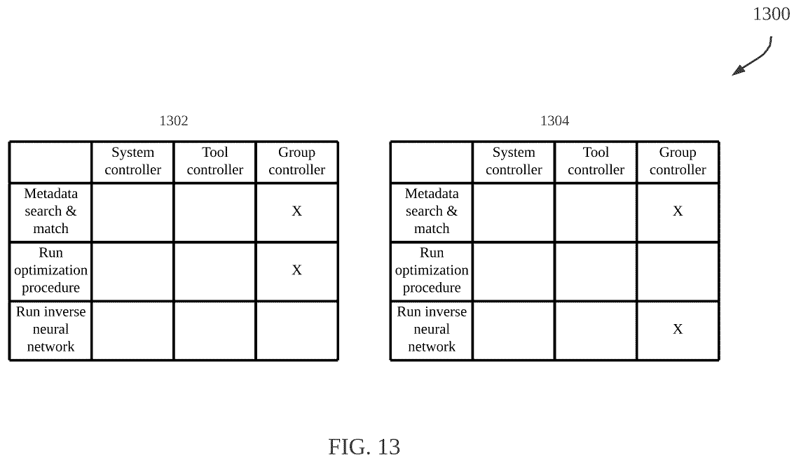

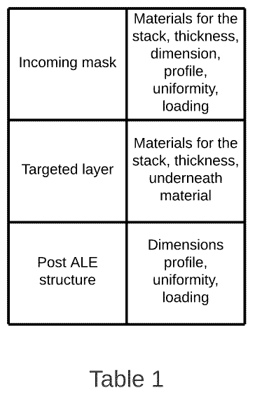

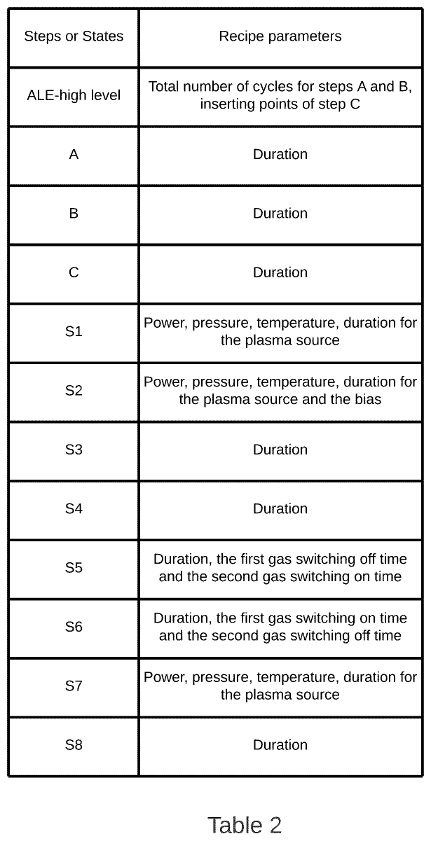

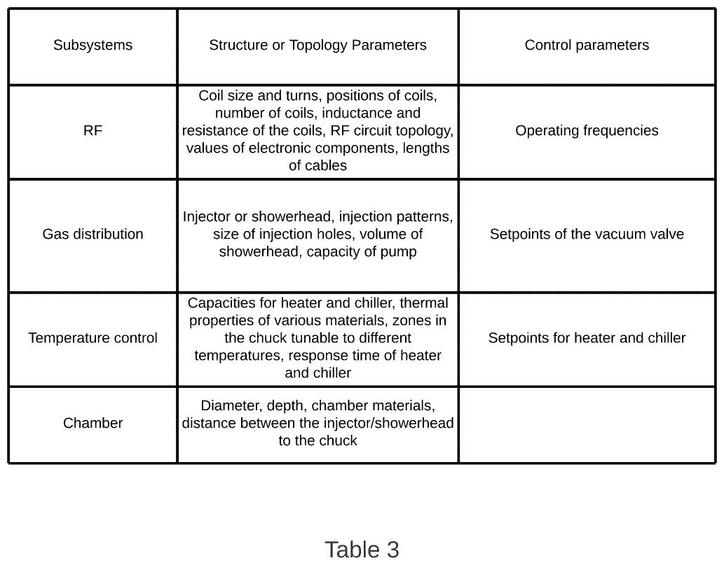

FIGS. 11-13 illustrate various implementations of the procedures (160, 162, and 164). In FIG. 11, procedure 160 is implemented as part of the system controller 132, while procedures 162 and 164 may optionally be executed by any of the controllers as shown from 1102 to 1112. In FIG. 12, procedure 162 is incorporated into the tool controller 133, while procedures 162 and 164 can alternate between the tool controller 133 and the group controller 135 as shown in 1202 to 1212. In FIG. 13, all procedures are part of the group controller 135 as shown in 1302 and 1304. The configurations shown in FIGS. 11-13 are exemplary and not exhaustive. Other implementations are possible, and all such variations fall within the scope of the present invention.

1. A process system for real-time process recipe generation and adjustment, comprising:
a vacuum chamber configured with a plurality of subsystems to enable a process for a substrate comprising a plurality of steps;
a system controller configured to supervise operations of the process system, including a system digital twin that models operations of the process system; and
a recipe generation and adjustment procedure executed under the supervision of the system controller, including a metadata search-and-match procedure, wherein the metadata stored in a database describes previously simulated or real process events.

2. The process system of claim 1, wherein the recipe generation and adjustment procedure includes an optimization procedure that minimizes a cost function, representing the difference between the predicted output parameters and the targeted ones.

3. The system of claim 1, wherein the recipe generation and adjustment procedure includes an inference operation utilizing an inverse neural network.

4. The process system of claim 1, wherein the system controller is further coupled to a tool controller, and wherein one or more of the procedures is executed by the tool controller, which supervises operations of a tool with a plurality of the process systems.

5. The process system of claim 4, wherein the system controller is further coupled to a group controller, and wherein one or more of the procedures is executed by the group controller, which supervises operations of a plurality of tools.

6. The process system of claim 1, wherein the metadata search-and-match procedure includes a metadata structure comprising inputs fields that describe a process step and structures before and after the process step.

7. The process system of claim 6, wherein the metadata search-and-match procedure includes computing an error function, wherein the error function quantifies the difference between parameters of the input fields and a selected metadata.

8. The process system of claim 1, wherein the metadata search-and-match procedure includes a metadata structure comprising output fields that include subsystem control parameters and unfixed recipe parameters.

9. The process system of claim 1, wherein the system digital twin further includes a reactor digital twin comprising subsystem digital twins and a chamber plasma digital twin.

10. The process system of claim 9, the system digital twin further includes a process digital twin that uses outputs from the reactor digital twin as its inputs and calculates the outcome of a process step.

11. The process system of claim 1, wherein the process system includes an ALE process system.

12. The process system of claim 1, wherein the process system includes one selected from the group consisting of a RIE, PECVD, ALD, and thermal process systems.

13. A method for generating and adjusting a process recipe for a semiconductor process system, the method comprising:
providing by a system controller a system digital twin that includes a plurality of subsystem digital twins, a chamber plasma digital twin, and a process digital twin;
calibrating by the system controller input parameters of the system digital twin;
generating recipe and subsystem control parameters prior to initiating the processing of a substrate;
predicting the outcome of a process step during the processing by utilizing the system digital twin and real-time measurement data; and
adjusting the recipe and the subsystem control parameters by the system controller for subsequent steps if the predicted outcome fails to meet the specified outputs, wherein the adjustment procedure includes a metadata search-and-match procedure, wherein metadata stored in a database describing previously simulated or real process events.

14. The method of claim 13, wherein the adjustment procedure includes an optimization procedure that minimizes a cost function representing the difference between the predicted output parameters and the targeted ones.

15. The method of claim 13, wherein the adjustment procedure includes an inference operation utilizing an inverse neural network.

16. The method of claim 15, wherein the inverse neural network is trained using simulation data provided by the system digital twin.

17. The method of claim 13, wherein the method further includes accumulating simulated process events in the background.

18. The method of claim 13, wherein the method further includes executing one or more of the procedures by a tool controller, wherein the tool controller supervises operations of a tool with a plurality of the process systems.

19. The method of claim 13, wherein the method further includes executing one or more of the procedures by a group controller, wherein the group controller supervises operations of a plurality of tools.

20. The method of claim 13, wherein the method further includes training neural networks that represent subsystem digital twins, the chamber plasma digital twin, and the process digital twin for the system digital twin.
